(19) United States
(12) Patent Application Publication
(10) Pub. No.: US 2024/0380820 A1
(43) Pub. Date: Nov. 14, 2024

(54) VEHICLE CONTROL SYSTEM, VEHICLE CONTROL METHOD, AND VEHICLE CONTROL PROGRAM PRODUCT

(71) Applicant: DENSO CORPORATION, Kariya-city (JP)

(72) Inventors: Ataro YAMADA, Kariya-city (JP); Satoshi NIWA, Kariya-city (JP)

(21) Appl. No.: 18/780,937

(22) Filed: Jul. 23, 2024

Related U.S. Application Data
(63) Continuation of application No. PCT/JP2023/007771, filed on Mar. 2, 2023.

(30) Foreign Application Priority Data
Mar. 22, 2022 (JP) 2022-032029

(51) Int. Cl. H04L 67/125; B60W 50/06

(52) U.S. Cl. CPC H04L 67/125; B60W 50/06; B60W 2050/065

(57) ABSTRACT

A vehicle control system includes at least one vehicle control device controlling a vehicle and an operation control device disposed separate from the at least one vehicle control device. The operation control device includes an operation control unit that controls a control target included in the vehicle. The vehicle control system is configured to: receive commands from multiple applications; determine, in response to receiving a first command from one of the multiple applications, whether the first command related to the control target is acceptable; transmit a determination result to the one of the multiple applications; and in response to determining that the first command is acceptable, output a second command based on the first command to the operation control unit.

### CROSS REFERENCE TO RELATED APPLICATIONS

The present application is a continuation application of International Patent Application No. PCT/JP2023/007771 filed on Mar. 2, 2023, which designated the U.S. and claims the benefit of priority from Japanese Patent Application No. 2022-032029 filed on Mar. 2, 2022. The entire disclosures of all of the above applications are incorporated herein by reference.

### TECHNICAL FIELD

The present disclosure relates to a vehicle control system in which a vehicle control device controls a control target, and also relates to a vehicle control method and a vehicle control program product.

### BACKGROUND

Conventionally, in a vehicle control system, when the vehicle control system receives a request, another request is rejected for a certain period of time, and a rejection notification is performed during this period.

### SUMMARY

The present disclosure provides a vehicle control system, which includes at least one vehicle control device controlling a vehicle and an operation control device disposed separate from the at least one vehicle control device. The operation control device includes an operation control unit that controls a control target included in the vehicle. The vehicle control system is configured to: receive commands from multiple applications; determine, in response to receiving a first command from one of the multiple applications, whether the first command related to the control target is acceptable; transmit a determination result to the one of the multiple applications; and in response to determining that the first command is acceptable, output a second command based on the first command to the operation control unit.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of a vehicle control system;

FIG. 2 is a ladder chart showing a basic operation executed in a vehicle control system according to an embodiment;

FIG. 3 is a ladder chart showing an exemplary operation when multiple requests to open and close a sliding door are received;

FIG. 4 is a ladder chart showing an exemplary operation when a sliding door open request and an air conditioner start request conflict with one another;

FIG. 5 is a ladder chart showing a setting example for transmitting an operation result; and

FIG. 6 is a ladder chart showing a basic operation executed in a vehicle control system according to another embodiment.

### DETAILED DESCRIPTION

As described above, in a conventional vehicle control system, when the vehicle control system receives a request, another request is rejected for a certain period of time, and a rejection notification is performed during this period. In this configuration, when a request is accepted, after completion of a processing in response to the request, a processing result indicating completion of the processing is notified.

After performing detailed study, the inventors of the present disclosure found that, in the above vehicle control system, when a request is accepted, the processing result is not notified until the processing is completed. In this configuration, it is impossible to perform feedback control during execution of the processing, and it may degrade convenience of the system.

According to an aspect of the present disclosure, a vehicle control system includes at least one vehicle control device controlling a vehicle and an operation control device disposed separate from the at least one vehicle control device. The operation control device includes an operation control unit that controls a control target included in the vehicle. The vehicle control system includes an input unit, an acceptance determination unit, a determination transmission unit, and an output unit.

The input unit is configured to receive commands from multiple applications.

The acceptance determination unit is configured to determine, in response to a first command being input from one of the multiple applications to the input unit, whether the first command related to the control target is acceptable. The determination transmission unit is configured to transmit a determination result determined by the acceptance determination unit, to the one of the multiple applications.

The output unit is configured to output a second command based on the first command to the operation control unit when the acceptance determination unit determines that the first command is acceptable.

According to the above configuration, it is possible to determine whether the first command is acceptable, and cause the application to quickly recognize the determination result of whether the first command is acceptable. Therefore, the application can quickly perform processing based on the determination result, thereby improving convenience of application.

According to another aspect of the present disclosure, the acceptance determination unit may implement the function of the first determination unit, which determines whether the first command is acceptable based on at least one of the vehicle equipment, the vehicle state, or the command syntax included in the first command.

With this configuration, the determination result based on at least one of the vehicle equipment, the vehicle state, or the command syntax can be immediately transmitted to the application.

The following will describe embodiments of the present disclosure with reference to the drawings.

### 1. Embodiment

### (1-1. Correspondence Relationship Between Configuration of Embodiment and Configuration of Present Disclosure)

In the embodiment, any one of ECUA 10, ECUC 20, ECUD 25, and ECUE 30 (hereinafter referred to as ECUs 10 to 30) corresponds to a vehicle control device of the present disclosure. The memories 12, 22, 27, and 32 correspond to a storage of the present disclosure. Among the functions executed by any one of the ECUs 10 to 30, a function of a vehicle service unit 7 and a function of a state management unit 8 are implemented by a vehicle control program of the present disclosure. The vehicle service unit 7 corresponds to a first management unit of the present disclosure, the state management unit 8 corresponds to a second management unit of the present disclosure, and an equipment management unit 9 corresponds to a third management unit of the present disclosure.

In the process executed by any one of the ECUs 10 to 30, the processes executed in S10 and S20 of the embodiment corresponds to a function of an acceptance determination unit of the present disclosure, the process executed in S10 of the embodiment corresponds to a function of a first acceptance determination unit of the present disclosure, and the process executed in S20 of the embodiment corresponds to a function of a second acceptance determination unit of the present disclosure. The process executed in S20, S110, and S160 of the embodiment corresponds to a function of an output unit of the present disclosure, and the process executed in S120, S140, and S150 of the embodiment corresponds to a function of a determination transmission unit of the present disclosure.

The process executed in S120 of the embodiment corresponds to a function of a first transmission unit of the present disclosure, the process executed in S140 and S150 of the embodiment corresponds to a function of a second transmission unit of the present disclosure, and the process executed in S40 and S170 to S190 of the embodiment corresponds to a function of an operation transmission unit of the present disclosure.

### (1-2. Configuration)

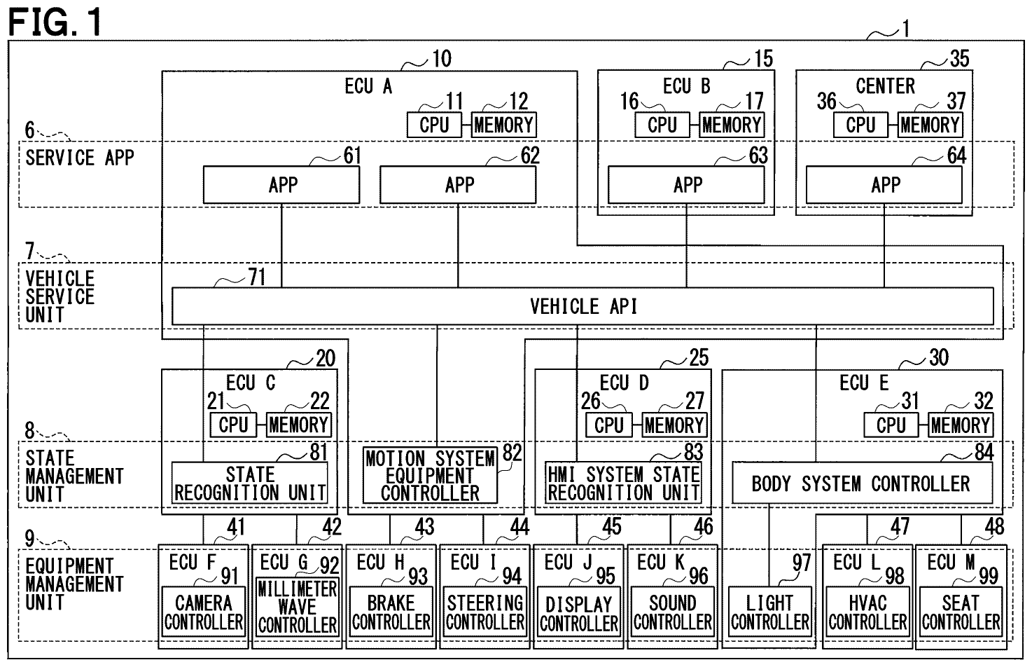

As shown in FIG. 1, most components of a vehicle control system 1 are mounted on a vehicle, such as a passenger car, and include multiple ECUs 10, 15, 20, 25, 30, 41 to 48 (hereinafter referred to as multiple ECUs 10). The vehicle control system 1 may include a center 35 located outside the vehicle.

The center 35 is implemented by a server, which is capable of providing a function to the vehicle. For example, the center 35 can provide the vehicle with a function related to automated driving.

Each of the multiple ECUs 10 and the center 35 mainly include a microcomputer. Each microcomputer includes a CPU 11, 16, 21, 26, 31, 36 (hereinafter referred to as CPUs 11 to 36) and a semiconductor memory 12, 17, 22, 27, 32, 37 (hereinafter referred to as memories 12 to 37). The semiconductor memory may be a RAM, a ROM, or a flash memory. Each of the ECUs 41 to 48 also includes a CPU and a memory, but detailed configurations are not shown in the drawings. ECU indicates electronic control unit.

The multiple ECUs 10 and the center 35 are configured to control a control target mounted on the vehicle. The control target includes, for example, an engine, a brake, a motor, various lights, display devices, air conditioners, seats, a horn, a generator, or the like. Note that illustration of the control target is omitted in the drawings.

Multiple control targets are respectively controlled by the ECUs 41 to 48, which correspond to operation control devices. The ECUs 41 to 48 include an ECUF 41 including a camera controller 91, an ECUG 42 including a millimeter wave controller 92, an ECUH 43 including a brake controller 93, and an ECUI 44 including a steering controller 94. The ECUs 41 to 48 also include an ECUJ 45 including a display controller 95, an ECUK 46 including a sound controller 96, an ECUL 47 including an HVAC controller 98, and an ECUM 48 including a seat controller 99.

Each of the controllers 91 to 99 includes an operation control program for operating a control target. The camera controller 91 acquires a captured image of a vehicle-mounted camera and controls exposure and the like of the vehicle-mounted camera. The millimeter wave controller 92 controls a millimeter wave radar equipped to the vehicle and acquires a detection result obtained by the millimeter wave radar.

The brake controller 93 controls a brake. The steering controller 94 controls steering. The display controller 95 controls a display, such as a meter or a warning light. The sound controller 96 controls a sound such as a warning sound and a voice generated from a speaker. The light controller 97 controls various lights mounted on the vehicle. Note that the light controller 97 is included in the ECUE 30.

The HVAC controller 98 controls an in-vehicle air conditioner. Note that HVAC is an abbreviation for Heating Ventilation and Air-Conditioning. The seat controller 99 controls an electric power seat of the vehicle.

Various functions of multiple ECUs 10 and the center 35 are implemented by the CPUs 11 to 31 executing a program stored in a non-transitory tangible storage medium. In this example, the memories 12 to 32 correspond to the non-transitory tangible storage medium that store the programs. By executing the program corresponding to the function of controller, a method corresponding to the program is executed. Note that the non-transitory tangible storage medium means a storage medium that does not use electromagnetic waves. The number of microcomputers constituting the multiple ECUs 10 and the like and the center 35 may be one or more.

Among the multiple ECUs 10, the ECUA 10 executes a program to implement functions as applications (hereinafter also referred to as app) 61 and 62, a vehicle API 71, and a motion system equipment controller 82. The ECUB 15 implements a function as an application 63. The center 35 implements a function as an application 64.

The applications 61 to 64 each is a program for providing a service to a user of the vehicle. The applications 61 to 64 each indirectly transmits a command to the control target and provides a useful function to the user by operating the control target. These applications 61 to 64 may be installed in the ECUA 10. Alternatively, the applications 61 to 64 may be installed in the ECUB 15. Alternatively, the applications 61 to 64 may be installed in the center 35.

The applications 61 to 64 each is configured to generate a first command that is a command not designating the controller 91 to 99 toward the vehicle API 71. Details about the first command will be described later. Note that the command includes a command such as an operation request, a command such as an argument, and a function call, among data to be used by the vehicle API 71. The command may include priority information indicating which command is to be preferentially processed.

Each of the applications 61 to 64 is not a dedicated program created for a specific vehicle type, a specific grade, or the like. Each of the applications 61 to 64 is a general-purpose program that can support various types of vehicles, various grades, or the like. Thus, each of the applications 61 to 64 cannot specify how the vehicle in which the application is installed controls the control target. Therefore, each of the applications 61 to 64 outputs a command, which does not define a specific control amount of the control target. In other words, each of the applications 61 to 64 outputs a command, which does not designate the controller 91 to 99 to be used by the vehicle API 71. Each of the applications 61 to 64 generates an expected generalized operation content. For example, each of the applications 61 to 64 may simply instruct turn-on of a light, without specifying which light to be turned on. The vehicle API 71 provides an API that can command generalized operation content.

In the following description, at least one of the applications 61 to 64 is also referred to as a service application 6.

Unlike the applications 61 to 64, the vehicle API 71 is a program created for a specific vehicle type, a specific grade, or the like. That is, the vehicle API 71 is a program that absorbs differences in vehicle type, grade, and the like such that the applications 61 to 64 do not need to recognize the differences in vehicle type, grade, and the like. The vehicle API 71 is a program that functions as an API for adapting a command used by each of the applications 61 to 64 and a command used by the state management unit 8 and the equipment management unit 9 to be described later. API is an abbreviation for Application Programming Interface.

The vehicle API 71 is installed in the ECUA 10. The vehicle API 71 receives commands from multiple applications 61 to 64. The multiple applications 61 to 64 are installed in the ECUA 10 that includes the vehicle API 71, the ECUB 15 that is another ECU, and the center 35.

Hereinafter, at least one of the vehicle APIs 71 is also referred to as a vehicle service unit 7. Note that the vehicle service unit 7 may include multiple vehicle APIs.

The ECUC 20 implements a function as a state recognition unit 81. The ECUD 25 implements a function as an HMI system state recognition unit 83. The ECUE 30 implements a function as a body system controller 84. Hereinafter, at least one of the state recognition unit 81, the motion system equipment controller 82, the HMI system state recognition unit 83, or the body system controller 84 is also referred to as the state management unit 8.

The state management unit 8 is one of programs for controlling the control target. The state management unit 8 may calculate an operation amount of an actuator, which corresponds to the control target, and transmits a command including the operation amount, to the various controllers 91 to 99. The state management unit 8 has a function of generating a second command, which specifies the generalized first command, in response to input of the generalized first command. Note that the vehicle service unit 7 may have a function of generating the second command, which specifies the first command.

The state management unit 8 is also a program for transmitting data obtained from sensors to the service application 6. That is, the state management unit 8 implements a state recognition function and an equipment control function. The state recognition function converts sensor data obtained from the equipment management unit 9 (each controller 91 to 99 to be described later) into a format suitable for the vehicle service unit 7, and transmits the converted data to the vehicle service unit 7. In the equipment control function, a drive instruction from the vehicle service unit 7 is distributed to the equipment management unit 9.

The state management unit 8 may be installed in the same ECUA 10 as the ECU in which the vehicle API 71 is installed. Alternatively, the state management unit 8 may be installed in the ECUC 20, ECUD 25, or ECUE 30, which corresponds to another ECU. The state management unit 8, which includes at least one of the state recognition unit 81, the motion system equipment controller 82, the HMI system state recognition unit 83, or the body system controller 84, may all be installed in the same ECUA 10 as the ECU in which the vehicle API 71 is installed. Alternatively, the state management unit 8 may be installed in distributed manner, that is, in each ECU that controls each domain.

In the state recognition function, individual sensor raw data acquired by the equipment management unit 9 from the vehicle sensors are classified into data for each sensing target such that the service application 6 can easily use the classified data. The state recognition function also integrates the data such that the data can be converted into information with a higher generalization level, and then transmits the information to the vehicle service unit 7.

For example, in the state recognition function, each of the controllers 91 to 99 constituting the equipment management unit 9 acquires individual information element, such as a vehicle speed of 0 km/h, a shift position P, and absence of a driver in the vehicle, and outputs a signal indicating that the vehicle is in a parked state on the basis of these information elements. These information elements are further transmitted to the service application 6 via the vehicle service unit 7.

For example, when the service application 6 makes a request regarding a car finder service, the vehicle service unit 7 may respond to the service application 6 by combining an ACK from the light, which is a response to a control request of light, and an ACK from the horn, which is a response to a control request of horn, into a single operation result. The car finder is a function of an application that notifies the user of a position of the vehicle within a parking lot in an easy-to-understand manner.

The equipment control function selects one of the controllers 91 to 99 (e.g., controller that controls the corresponding control target, such as the engine, steering, shift, doors, windows, air conditioner, etc.) in the equipment management unit 9, which is optimal for performing the vehicle operation request transmitted from the service application 6. The equipment control function convert the data format into a format that can be received by each of the controllers 91 to 99, and distributes the data with consideration of transmission order of data.

For example, when the vehicle operation request from the service application 6 is “turn left with a radius of 200 m and acceleration of 0.3 G”, the equipment control function outputs “request engine output of 1000 Nm and request steering output of −0.1 rad”.

For example, suppose that the vehicle operation request from the service application 6 is “transition to a parking state.” In this case, the equipment control function outputs “request for setting a shift to P, a request for an air conditioner to be off, a request for a window to be fully closed, a request for a door to be locked when the requests described above are completed and there is no occupant in the vehicle, and then a request for transition to a parking state”.

The state management unit 8 is divided into multiple programs such that each program corresponds to each type of vehicle operation. Each type of vehicle operation corresponds to each type of the first command. The type of vehicle operation includes, for example, a traveling system related to turning, traveling, and stopping of the vehicle, an HMI system related to information presentation to the user, a body system related to a state change of the body, and the like. As described above, in the state management unit 8, each of management functions 81 to 84 is provided according to the type of domain. The programs of the management functions are stored in the memory 22 of the ECUC 20, the memory 27 of the ECUD 25, the memory 32 of the ECUE 30, or the memory 12 of the ECUA 10. The ECUC 20, ECUD 25, and ECUE 30 each corresponds to the domain control unit. The ECUA 10 corresponds to the central unit.

The state management unit 8 is classified for each vehicle operation that is likely to be requested by the service application 6, but not for each implementation function (for example, the controllers 91 to 99) that is likely to depend on the vehicle variation.

The state recognition unit 81 acquires information from the camera controller 91 and the millimeter wave controller 92, converts the acquired information into information indicating the positions of the vehicle and the pedestrian, and outputs the converted information to the vehicle service unit 7.

The motion system equipment controller 82 converts the operation request of the vehicle into specific control amounts of the brake controller 93 and the steering controller 94, and outputs the converted control amounts.

The HMI system state recognition unit 83 determines, in response to a reception of warning command, whether to perform notification using the display controller 95 and the sound controller 96, and outputs the corresponding control amount.

For example, the body system controller 84 determines, in response to a reception of a command related to the vehicle environment, which one of the light controller 97, the HVAC controller 98, or the seat controller 99 is to be operated. Then, the body system controller converts the command related to the vehicle environment into an appropriate command, and then outputs the converted command.

As described above, the architecture within the vehicle network is configured in layered manner, such that the first layer is the equipment management unit 9, the second layer is the state management unit 8, the third layer is the vehicle service unit 7, and the fourth layer is the service application 6.

### (1-3. Process)

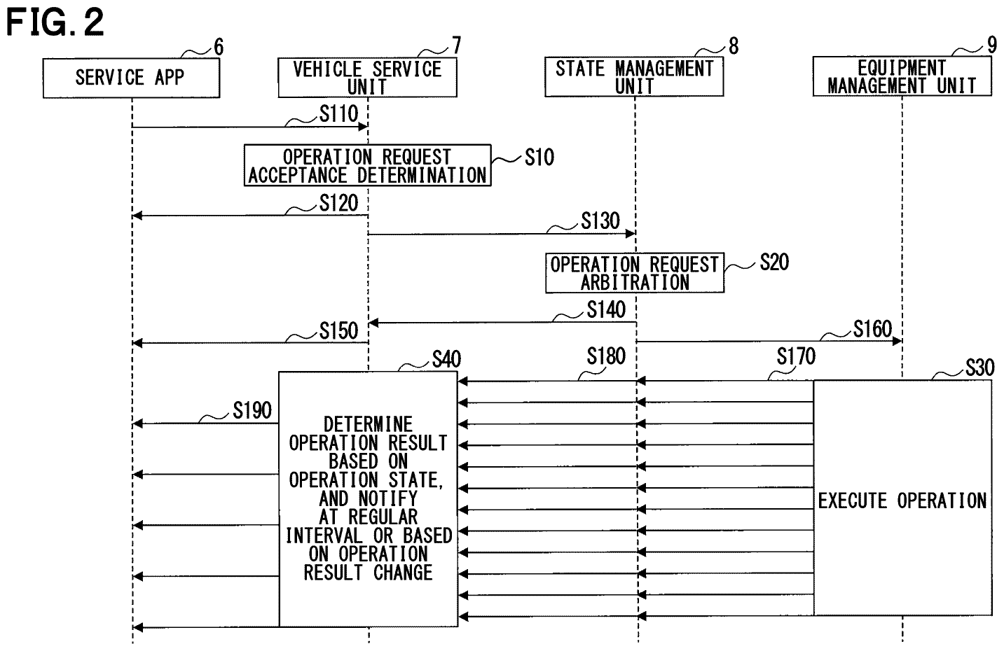

The following will describe a basic process executed by the vehicle control system 1 with reference to a ladder chart shown in FIG. 2.

In S110, the service application 6 transmits an operation request (that is, the first command in the present disclosure) to the vehicle service unit 7. The vehicle service unit 7 performs an operation request acceptance determination for determining whether a request for operation is accepted in S10. The operation request acceptance determination is a process of determining whether each of the controllers 91 to 99 can accept the first command.

In S10, the vehicle service unit 7 is configured to determine whether the first command can be accepted based on at least one of the vehicle equipment, the vehicle state, or a command syntax of the first command included in the first command. Note that the vehicle equipment and vehicle state respectively indicate the equipment and state of the vehicle in which the vehicle control system 1 is installed.

In S10, the vehicle service unit 7 determines whether to accept the operation request from the service application 6 based on, for example, the following six items.
(1) Syntax: Whether an error exists in an API syntax of the program.
(2) Equipment information: Whether the vehicle is equipped with the control target required to operate.
(3) Operation possible level: Whether the equipment required to operate can currently accept the operation request.
(4) Authentication/Authorization: Whether the service application 6 corresponding to request source is authenticated, and whether the service application 6 has an access right to the vehicle service unit 7.
(5) Abnormality in vehicle service unit 7: Whether an abnormality (for example, a data or communication abnormality, an operation other than specified normal operation, and the like) is occurred in the vehicle service unit 7.
(6) Cache state: After the state management unit 8 determines that the command cannot be accepted, whether a period of time for enabling acceptance of the same command is elapsed.

Note that in item (3), the state of “equipment can accept” indicates that the operation request range or the number of possible requests within a certain period are within a predetermined range. The number of possible requests within the range indicates the number of received requests is within the predetermined period of time. In item (3), the operation request that does not match the vehicle state is rejected. For example, during traveling at 100 km/h, a request to open the door is rejected.

In item (5), depending on the combination of vehicle API 71 and the unacceptable contents, whether to cache the unacceptable information for each request source or whether to cache the unacceptable information regardless of the request source is changed.

The determination items may be properly set for each vehicle API 71 in the vehicle service unit 7. That is, determination may be omitted for some of the above-described items. The equipment information of the vehicle equipment, the authentication state of the service application 6 and the presence or absence of access right, the current vehicle state related to the equipment, and abnormality information of the vehicle service unit may be stored in the memory 12. The information that the vehicle service unit 7 refers to when determining whether to accept the request, such as the cache state information is also stored in the memory 12.

In S120, the vehicle service unit 7 transmits a determination result indicating whether the first command can be accepted, to the service application 6. That is, the vehicle service unit 7 transmits the determination result to the service application 6 before the equipment management unit 9 receives an operation instruction in S160.

The vehicle service unit 7 transmits the operation request to the state management unit 8 in S130. The operation request in S130 is transmitted only when it is determined that the first command can be accepted. The operation request corresponds to a management command of the present disclosure.

When the state management unit 8 receives the operation request from the vehicle service unit 7, the state management unit 8 performs operation request arbitration in S20. In the operation request arbitration, the state management unit 8 determines whether the first command can be accepted with consideration of the first command and a competition between the first command and another command different from the first command. The state management unit 8 may determine whether the request can be accepted, with consideration of a competition between a request received by the API 71 (for example, the vehicle API 71) and a request received by another API (for example, another vehicle API) that is different from the API (for example, the vehicle API 71) that has received the request.

The above-described operation request acceptance determination refers to the vehicle state and determines whether the operation request can be accepted regardless of other commands. However, the operation request arbitration determines whether the operation request can be accepted with consideration of the competition with other commands. When the state management unit 8 can accept the operation request, the state management unit 8 generates a second command that specifies the generalized first command as the operation instruction.

The state management unit 8 determines whether the operation request can be accepted based on, for example, the following five items.
(1) Request priority arbitration: Whether the first command has a higher priority than requests based on other applications or user operations.
(2) Cancellation request by request source: Whether the request source has requested cancellation of the request and the request is being processed.
(3) Cancellation request by user: Whether a stop request by user is occurred.
(4) Request processing load overload: Whether the number of multiple requests received by the control target is equal to or more than the possible processing number.
(5) Abnormality in state management unit 8 or equipment management unit 9: Whether an abnormality (for example, data or communication abnormality, an operation other than specified normal operation) is occurred in the state management unit 8 or the equipment management unit 9.

In item (1), the priority is specified by the application, and the operation based on the priority is determined by the receiving side. However, the receiving side may ignore the priority specified by the application when performing the operation.

For example, when the state management unit 8 receives a request to turn on an air conditioner and a request to turn on a light, the voltage may decrease to a level lower than an electrically allowable threshold if both of the two requests are accepted. In this case, the state management unit 8 determines that both requests cannot be accepted. When the state management unit 8 receives a request related to acceleration and a request related to steering, the vehicle drive control amount that satisfies both requests may cause the vehicle to deviate from the traveling road or lane. In this case, the state management unit 8 determines that both requests cannot be accepted. The priority information for each request, information related to cancellation by request source, information related to cancellation by user, and threshold values that can be processed by the control target (for example, number of requests, control amount, processing load, etc.) are stored in the memory 12 or the memory 22, 27, 32. Information that the state management unit 8 refers to when determining acceptance of request, such as abnormality information of the state management unit 8 or the equipment management unit 9 is stored in the memory 12 or the memory 22, 27, 32.

The threshold value that can be processed by the control target may be properly changed corresponding to the situation. Specifically, the service application 6 or the state management unit 8 may update the threshold stored in the memory 12 or memory 22, 27, 32 in accordance with data (for example, a new threshold) obtained from the vehicle or data obtained from a device located outside the vehicle.

The state management unit 8 may determine whether the first command can be accepted in consideration of whether a processing amount related to the first command and another command is acceptable. More specifically, the state management unit 8 may determine whether the first command can be accepted by comparing the processing amount related to the first command and another command with a threshold value stored in the memory 12 or the memory 22, 27, 32.

For example, when the operation control program constituting each of the controllers 91 to 99 is updated by OTA, the service application 6 and the state management unit 8 may receive new threshold values from the center 35 and update the threshold values stored in the memory 12 or the memory 22, 27, 32. OTA is an abbreviation for Over The Air.

For example, when deterioration of a battery is detected in the vehicle, the allowable value of remaining battery capacity may be updated. When the battery deterioration is detected, the allowable value of remaining battery capacity may be updated to a value (for example, 25%) higher than a normal value (for example, 20%).

In S140, the state management unit 8 transmits the determination result of S20 (that is, the arbitration result) to the service application 6 before the second command is transmitted to each of the controllers 91 to 99 (that is, the equipment management unit 9). The vehicle service unit 7 relays the arbitration result transmitted from the state management unit 8, and transmits the arbitration result to the service application 6 in S150. The state management unit 8 outputs the second command (that is, the operation instruction) generated based on the first command to each of the controllers 91 to 99 of the equipment management unit 9 in S160.

Each of the controllers 91 to 99 is equipped with an operation control program for operating the control target. Each of the controllers 91 to 99 in the equipment management unit 9, in response to receiving the operation instruction, executes the operation control program. The memory in each of the ECUs 41 to 48, each of which corresponds to the operation control device, stores the operation control program functioning as corresponding controller 91 to 99, and the program is executed by the CPU.

Each of the controllers 91 to 99 executes the operation control of the control target based on the second command (S30) as an operation control unit. In S170, each of the controllers 91 to 99 sequentially and repeatedly transmits the operation state of control target toward the communication line. For example, the operation state may be transmitted as CAN (registered trademark) data.

The operation state is received by the vehicle service unit 7 and the state management unit 8. The state management unit 8 may relay the received operation state to the vehicle service unit 7 in S180.

In S40, the vehicle service unit 7 receives the operation state transmitted from each of the controllers 91 to 99 of the equipment management unit 9, and recognizes the operation result based on the operation state. The operation result is data indicating whether the control target is operating normally or not. The vehicle service unit 7 transmits the operation result to the service application 6. The operation result is recognized based on data indicating the operation state of each of the controllers 91 to 99 acquired through the communication line.

The vehicle service unit 7 determines the operation result based on, for example, whether the operation state includes an alert, whether a value, such as a sensor value is within a normal range, whether a change rate of a value is within a normal range, etc. The operation result may include at least one of normal, abnormal, execution state, stop state, and the like.

The vehicle service unit 7 receives multiple operation states for the same data (predetermined data item) related to a certain control target. The vehicle service unit 7 transmits, in S190, the operation result to the service application 6 at regular intervals or when the difference (for example, change rate) between one operation state at a first time point and another operation state at a second time point satisfies a preset condition. For example, the vehicle service unit 7 may transmit vehicle speed data to the service application 6 every one second, or may transmit vehicle speed data to the service application 6 when the vehicle speed data changes from a stopped state to a moving state. The vehicle speed data may be transmitted to the service application 6 when a change rate of the vehicle speed data during traveling state is equal to or greater than a predetermined value.

The preset condition may be a condition that is properly set in advance. For example, the preset condition may be satisfied when the above-described operation possible level is changed, or when the operation state changes from execution state to stop state, or from stop state to execution state.

The vehicle service unit 7 transmits the operation result to the service application 6 at a lower frequency than the frequency at which the vehicle service unit 7 receives the operation states from the respective controllers 91 to 99. With this configuration, the processing load of the service application 6 can be reduced.

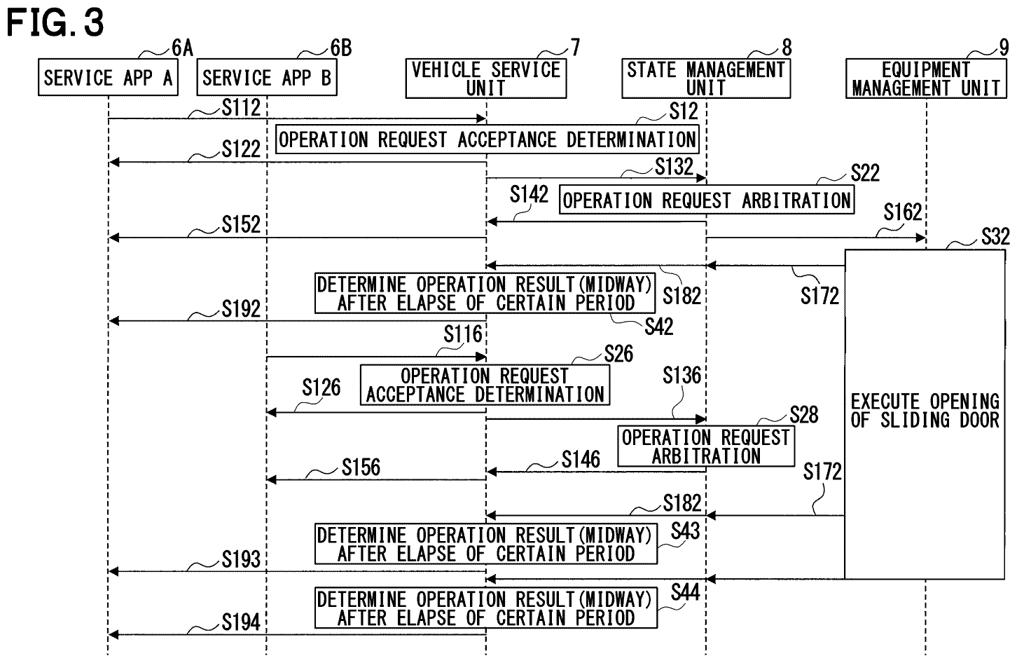

The following will describe detailed process executed by the vehicle control system 1 with reference to the ladder chart shown in FIG. 3. FIG. 3 illustrates an operation example in which multiple requests to open and close the sliding door are received as a specific example of the process shown in FIG. 2.

In the present example, two service applications 6A and 6B are provided as the service application 6, and suppose that the two service applications 6A and 6B receive different commands from one another.

In S112, the service application 6A transmits an opening request to the vehicle service unit 7 to open the sliding door. Then, the vehicle service unit 7 performs the operation request acceptance determination in S12.

The vehicle service unit 7 performs the same determination as in S10, and determines that the operation request can be accepted. In S122, the vehicle service unit 7 transmits, to the service application 6A, a message indicating that the first command can be accepted. Then, the vehicle service unit 7 transmits a sliding door open request to the state management unit 8 in S132.

When the state management unit 8 receives the request to open the sliding door from the vehicle service unit 7, the state management unit 8 performs the operation request arbitration in S22. In S22, the state management unit 8 determines that the sliding door open request can be accepted. In S142, the state management unit 8 transmits, to the service application 6A, a message indicating that the sliding door open request is acceptable. The vehicle service unit 7 relays the information indicating that the request is acceptable, and transmits the information indicating that the request is acceptable to the service application 6A in S152. The state management unit 8 outputs the second command (that is, a command to open the sliding door) based on the first command, to the equipment management unit 9 in S162.

In S172, the equipment management unit 9 sequentially and repeatedly transmits the operation state of the sliding door toward the communication line. The operation state here includes, for example, the position of sliding door, in opening operation state, in closing operation state, in stop state.

The operation state is received by the vehicle service unit 7 and the state management unit 8. The state management unit 8 may relay the received operation state to the vehicle service unit 7 in S182.

In S42, the vehicle service unit 7 receives the operation state transmitted from the equipment management unit 9, and recognizes the operation result based on the operation state. In S192, the vehicle service unit 7 transmits, to the service application 6A, a message indicating that the sliding door is in normal opening operation state.

Suppose that another command is received while the sliding door is in the operation state.

For example, in S116, the service application 6B transmits a stop request to the vehicle service unit 7 to stop the motion of sliding door. Then, the vehicle service unit 7 performs the operation request acceptance determination in S26.

The vehicle service unit 7 performs the same determination as in S10, and determines that the operation request can be accepted. In S126, the vehicle service unit 7 transmits, to the service application 6B, a message indicating that the first command can be accepted. Then, the vehicle service unit 7 transmits a sliding door stop request to the state management unit 8 in S136.

When the state management unit 8 receives the sliding door stop request from the vehicle service unit 7, the state management unit performs the operation request arbitration in S28. The state management unit 8 determines that the sliding door stop request cannot be accepted because the sliding door open request accepted at an early time has a higher priority.

In S146, the state management unit 8 transmits, to the service application 6B, a message indicating that the sliding door stop request cannot be accepted. The vehicle service unit 7 relays the message indicating that the request cannot be accepted, and in S156 transmits the message indicating that the request cannot be accepted, to the service application 6B. In this case, the state management unit 8 does not output the second command (that is, the sliding door stop request) to the equipment management unit 9. That is, the sliding door is not stopped midway during the opening operation, and continues to open completely.

The vehicle service unit 7 repeatedly receives the operation state transmitted from the equipment management unit 9 in S43 and S44, and recognizes the operation result based on the operation state each time receiving the operation state. In S193, the vehicle service unit 7 transmits, to the service application 6A, a message indicating that the sliding door is in normal opening operation. When the sliding door opening operation is completed, in S194, the vehicle service unit 7 transmits, to the service application 6A, a message indicating that the sliding door opening operation has been completed normally.

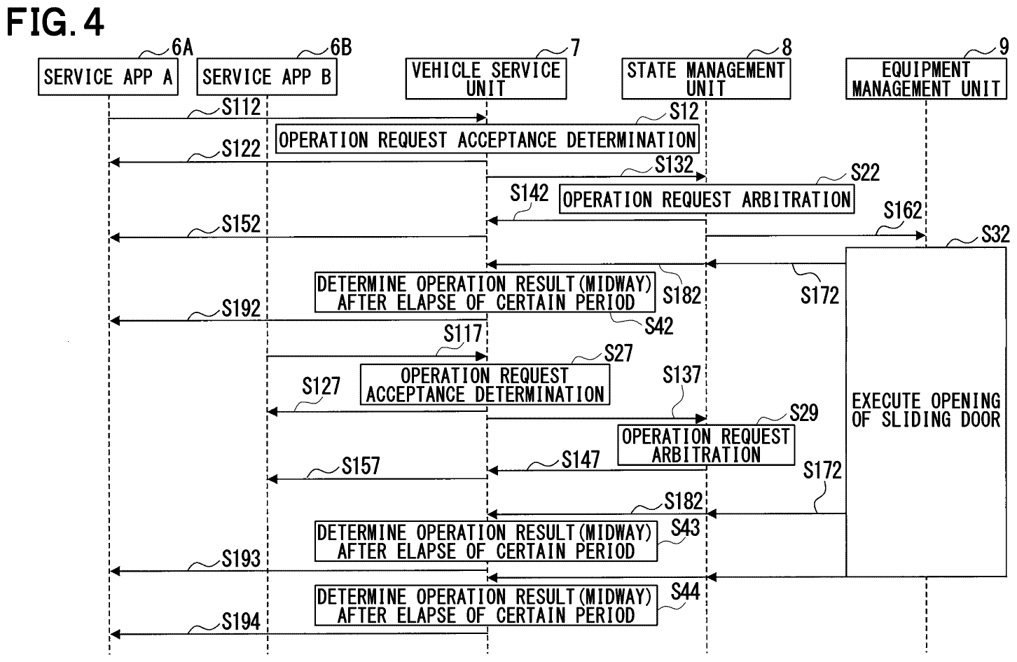

The following will describe an operation example in which the service application 6B outputs an air conditioner start request to start the air conditioner with reference to the ladder chart shown in FIG. 4. In this example, the operation in response to the slide door opening request from the service application 6A is the same as that shown in FIG. 3.

As shown in FIG. 4, the service application 6B transmits the air conditioner start request to the vehicle service unit 7 in S117. The vehicle service unit 7 performs the operation request acceptance determination in S27.

The vehicle service unit 7 performs the same determination as in S10, and determines that the operation request can be accepted. In S127, the vehicle service unit 7 transmits, to the service application 6B, a message indicating that the first command can be accepted. The vehicle service unit 7 transmits the air conditioner start request to the state management unit 8 in S137.

When the state management unit 8 receives the air conditioner start request from the vehicle service unit 7, the state management unit 8 performs the operation request arbitration in S29. The state management unit 8 determines that the air conditioner start request cannot be accepted because a sum of a power required for the already accepted sliding door open request and a power required for the air conditioner start request exceeds the allowable power threshold.

In S147, the state management unit 8 transmits, to the service application 6B, a message indicating that the air conditioner start request cannot be accepted. The vehicle service unit 7 relays the message indicating that the request cannot be accepted, and transmits, in S157, the message indicating that the request cannot be accepted to the service application 6B. In this case, the state management unit 8 does not output the second command (that is, the air conditioner start request) to the equipment management unit 9.

### (1-4. Effects)

According to the above-described embodiment, the following effects are achieved.

(1a) According to an aspect of the present disclosure, a vehicle control program is provided. The vehicle control program is executed by at least one of ECUs 10, 15, 20, 25, 30 to cause each of the controllers 91 to 99 to control actuators, lights, audio devices, and display devices, which are devices related to driving. The vehicle control program is implemented as the vehicle service unit 7 and the state management unit 8.

When a first command is input from the service application 6 in S110, the vehicle service unit 7 and the state management unit 8 output a second command, which is generated based on the first command, to each of the controllers 91 to 99 in S160. When the generalized first command is input in S20, the state management unit 8 generates the second command that is specified based on the first command.

Each of the controllers 91 to 99 is configured as a separate device from the ECUs 10, 15, 20, 25, and 30, and an operation control program is installed in each of the controllers 91 to 99. The operation control program controls each of the controllers 91 to 99.

In S10 and S20, the vehicle service unit 7 and the state management unit 8 determine whether each of the controllers 91 to 99 is capable of accepting the first command. The vehicle service unit 7 and the state management unit 8 transmit the determination result indicating whether the first command can be accepted, to the service application 6 in S120, S140, and S150 before the second command is transmitted to each of the controllers 91 to 99.

According to this configuration, the vehicle system can determine whether the first command is acceptable, and transmit the determination result to the service application 6 at an early stage. Thus, the service application 6 can execute a process corresponding to the determination result at an early stage, thereby improving the convenience of application.

(1b) In an aspect of the present disclosure, the vehicle service unit 7 is configured to determine, in S10, whether the first command can be accepted based on at least one of the vehicle equipment, the vehicle state, or the syntax of the command included in the first command.

According to this configuration, the determination result based on at least one of the vehicle equipment, the vehicle state, and the syntax of command can be immediately transmitted to the service application 6.

(1c) In an aspect of the present disclosure, the state management unit 8 determines, in S20, whether the first command can be accepted with consideration of the first command and a competition between the first command and another command different from the first command. The state management unit 8 may determine whether to accept the first command with consideration of a competition between the first command and a request received by another state management unit 8 of another API.

According to this configuration, it is possible to determine whether the first command can be accepted in consideration of the competition between the first command and other commands, and the result of this determination can be immediately transmitted to the service application 6.

(1d) In an aspect of the present disclosure, the vehicle service unit 7 transmits, in S120, the determination result of S10 to the service application 6 before the calculation of the determination result in S20 is completed. The state management unit 8 transmits the determination result of S20 to the service application 6 in S140.

According to this configuration, it is possible to cause the service application 6 to recognize the determination results of S10 and S20.

(1e) In an aspect of the present disclosure, the vehicle service unit 7 recognizes the operation result indicating whether each of the controllers 91 to 99 is operating normally in S40, S170 to S190, and then transmits the operation results to the service application 6. The operation results are recognized based on data indicating the operation state of each of the controllers 91 to 99. The operation results are acquired via the communication line.

According to this configuration, the operation result of each controller 91 to 99 is transmitted to the service application 6, so that the service application 6 does not need to calculate the operation result based on operation state. Thus, the operation result can be recognized with a simple configuration.

(1f) In an aspect of the present disclosure, the vehicle service unit 7 transmits, in S40, the operation result to the service application 6 at regular intervals or when a difference (for example, change rate) between one operation state and another operation state satisfies a preset condition.

According to this configuration, the operation result can be properly selected before transmission, so that the processing load of the service application 6 when processing the operation results can be reduced.

(1g) In an aspect of the present disclosure, the vehicle service unit 7 and the state management unit 8 output multiple second commands corresponding to multiple first commands to each of the controllers 91 to 99. At least a part of the vehicle service unit 7 and the state management unit 8 is configured to be divided into multiple programs for each type of vehicle operation corresponding to the type of first command.

According to this configuration, the vehicle operation type corresponding to the type of first command is divided into multiple programs, so that management such as maintenance of the programs can be facilitated.

### 2. Other Embodiments

While the present disclosure has been described with reference to embodiments thereof, it is to be understood that the disclosure is not limited to the embodiments and constructions.

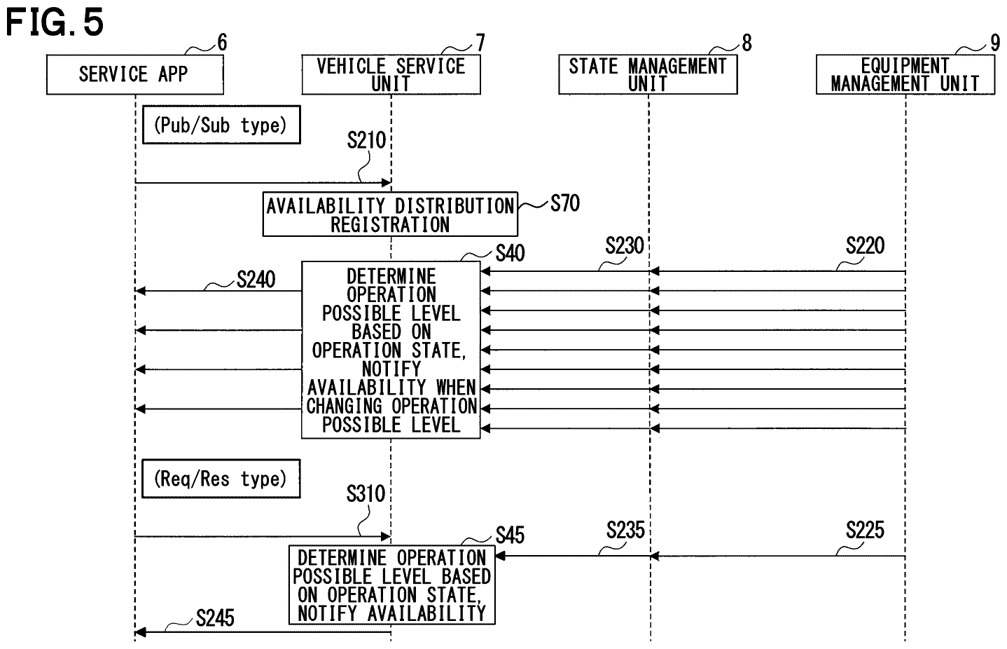

(2a) In the above embodiment, the vehicle service unit 7 is configured to transmit the operation result to the service application 6 in response to a satisfaction of preset conditions in S40. The present disclosure is not limited to this configuration. For example, as shown in FIG. 5, the service application 6 may set a transmission manner of the operation result by the vehicle service unit 7. In FIG. 5, the operation result in FIG. 2 is expressed as availability. Availability generally refers to a resistance of system to breakdown. In the present disclosure, availability indicates a concept that includes the determination result, such as a system failure, the above-described operation result, or the like.

The vehicle service unit 7 can employ either a Pub/Sub (Publish-Subscribe) type or a Req/Res (Request-Response) type. In a transmission method according to Pub/Sub type, once transmission parameters such as a transmission period of availability or the number of transmissions are registered, data is transmitted according to the set transmission parameters. In a transmission method according to the Req/Res type, data is transmitted in response to reception of a request.

In the case of Pub/Sub, the service application 6 preliminarily sets transmission parameters before S40. For example, the service application 6 transmits an availability distribution registration request to the vehicle service unit 7 in S210. Upon receiving the availability distribution registration request, the vehicle service unit 7 transmits an availability to the service application 6 in S240 in accordance with the settings of the transmission parameters included in the availability distribution registration request. The vehicle service unit 7 receives multiple operation states, which are transmitted by the equipment management unit 9 and the state management unit 8 in S220 and S230, and then generates the availability. At this time, the vehicle service unit 7 may determine the operation possible level (that is, whether the first command can be accepted) based on the operation state, and may properly change the setting of operation possible level. The vehicle service unit 7 may transmit availability when the setting of operation possible level is changed.

In the case of Req/Res type, the service application 6 transmits an availability distribution registration request to the vehicle service unit 7 in S310. Upon receiving the availability distribution registration request, the vehicle service unit 7 transmits the requested availability to the service application 6 in S245. The vehicle service unit 7 generates availability upon receiving at least one of the operation states, which are transmitted by the equipment management unit 9 and the state management unit 8 in S225 and S235. At this time, the vehicle service unit 7 may determine the operation possible level from the operation state, and transmit availability including the operation possible level.

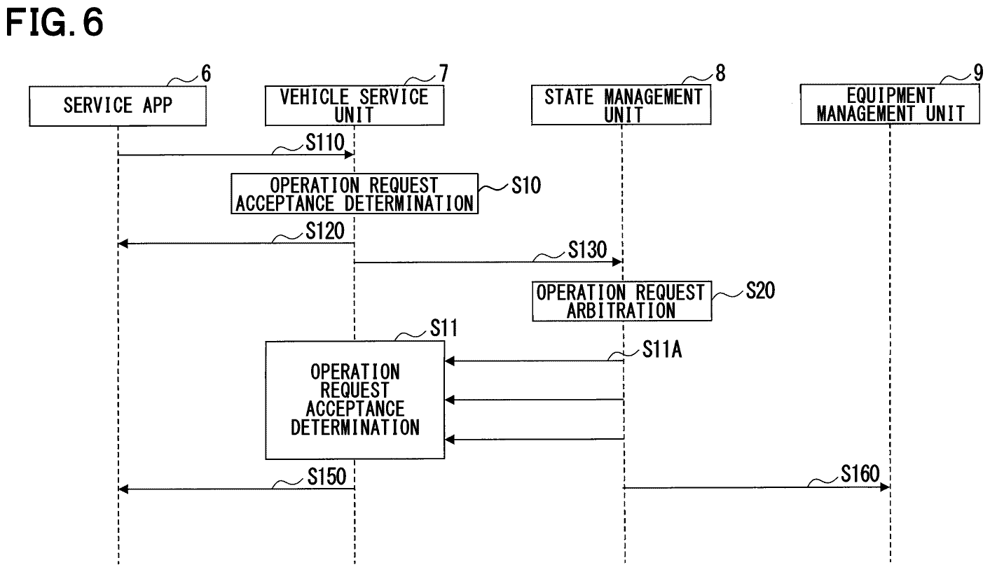

(2b) In the above embodiment, the state management unit 8 is configured to reply the arbitration result requested by the vehicle service unit 7. The present disclosure is not limited to this configuration. For example, as shown in FIG. 6, when the state management unit 8 is configured to be unable to reply the arbitration result of S20 requested by the vehicle service unit 7, the vehicle service unit 7 may be configured to execute the function of state management unit 8 instead of the state management unit 8 in S11. In this case, the vehicle service unit 7 acquires, in S11A, a part of the arbitration result transmitted from the state management unit 8, the operation state of the state management unit 8, and the operation state transmitted from the equipment management unit 9. The vehicle service unit 7 may use the acquired arbitration result and the operation states to perform partial or all of the operation request arbitration (for example, the process of S20). For example, the state management unit 8 may be configured to notify the vehicle service unit 7 of the acceptance result of the operation request transmitted from the vehicle service unit 7, the operation state of the state management unit 8 itself, and the operation state of the control target transmitted from the equipment management unit 9. In this configuration, the above-described operation request arbitration (S20, S22) may be performed by the vehicle service unit 7.

(2c) The functions of the acceptance determination unit, determination transmission unit, output unit, and operation execution unit in the present disclosure may be performed by at least one of the first management unit, the second management unit, or the third management unit. For example, one management unit may implement all of the functions of the acceptance determination unit, determination transmission unit, output unit, and operation execution unit. Alternatively, multiple management units may cooperate to implement theses functions as described in the above embodiment. When multiple management units cooperate to implement the above-described functions, each function may be implemented by any one of the management units.

(2d) The multiple ECUs 10 and the methods thereof described in the present disclosure may be implemented by a dedicated computer provided by a processor and memory programmed to perform one or more functions implemented by a computer program. Alternatively, the multiple ECUs 10 and the methods thereof described in the present disclosure may be implemented by a dedicated computer provided by a processor with one or more dedicated hardware logic circuits. Alternatively, the multiple ECUs 10 and the method thereof described in the present disclosure may be implemented by one or more special purpose computers configured by a combination of a processor and a memory programmed to execute one or multiple functions and a processor configured by one or more hardware logic circuits. The computer program may be stored in a computer-readable non-transitory tangible storage medium as instructions to be executed by a computer. The method for implementing the functions of respective units included in the multiple ECUs 10 does not necessarily need to include software, and all of the functions may be implemented with the use of one or more hardware circuits.

(2e) The multiple functions of one component in the above embodiments may be implemented by multiple components, or a function of one component may be implemented by multiple components. Multiple functions of multiple configuration elements in the above embodiments may be implemented by one configuration element, or one function implemented by multiple configuration elements may be implemented by one configuration element. A part of the configuration of the above embodiments may be omitted as appropriate. At least a part of the configuration in one embodiment may be added to or substituted for the configuration of another embodiment.

(2f) In addition to the vehicle control system 1 described above, the present disclosure can also be implemented in various manners, such as the ECUs 10 configuration the vehicle control system 1, a vehicle control program for causing a computer to function as the ECUs 10, a non-transitory tangible storage medium such as a semiconductor memory in which the program is recorded, and a vehicle control method.

What is claimed is:

1. A vehicle control system comprising:
at least one vehicle control device controlling a vehicle;
an operation control device disposed separate from the at least one vehicle control device and including an operation control unit that controls a control target included in the vehicle;
an input unit to which commands from multiple applications are input;
an acceptance determination unit determining, in response to a first command being input from one of the multiple applications to the input unit, whether the first command related to the control target is acceptable;
a determination transmission unit transmitting a determination result determined by the acceptance determination unit to the one of the multiple applications; and
an output unit outputting a second command based on the first command to the operation control unit when the acceptance determination unit determines that the first command is acceptable.

2. The vehicle control system according to claim 1, wherein
the acceptance determination unit includes a first determination unit that determines whether the first command is acceptable based on at least one of a vehicle equipment, a vehicle state, or a command syntax included in the first command.

3. The vehicle control system according to claim 1, wherein
the acceptance determination unit includes a second determination unit that determines whether the first command is acceptable with consideration of a competition between the first command and a third command, and
the third command is transmitted from another one of the multiple applications and is different from the first command and the second command.

4. The vehicle control system according to claim 3, wherein
the second determination unit determines whether the first command is acceptable with consideration of whether a processing amount related to the first command and the third command is acceptable.

5. The vehicle control system according to claim 4, further comprising
a storage storing a threshold value of the processing amount,
wherein the second determination unit updates the threshold value stored in the storage, and determines whether the first command is acceptable by comparing the processing amount related to the first command and the third command with the threshold value stored in the storage.

6. The vehicle control system according to claim 3, wherein
the acceptance determination unit includes a first determination unit that determines whether the first command is acceptable based on at least one of a vehicle equipment, a vehicle state, or a command syntax included in the first command, and
the determination transmission unit includes:
a first transmission unit transmitting a determination result by the first determination unit to the one of the multiple applications; and
a second transmission unit transmitting a determination result by the second determination unit to the one of the multiple applications.

7. The vehicle control system according to claim 1, further comprising
an operation transmission unit recognizing an operation result indicating whether the control target is operating normally and transmitting the operation result to the one of the multiple applications.

8. The vehicle control system according to claim 7, wherein
the operation transmission unit transmits, to the one of the multiple applications, the operation result at regular intervals or when a difference between one operation state at a first time point and another operation state at a second time point satisfies a preset condition regarding a specific data item of the control target.

9. The vehicle control system according to claim 1, wherein
the output unit outputs, to the operation control unit, a plurality of the second commands corresponding to a plurality of the first commands, and
at least a portion of the output unit is divided into multiple sections based on vehicle operation types, which correspond to types of the plurality of the first commands.

10. The vehicle control system according to claim 3, wherein,
when a battery voltage is estimated to decrease to a level lower than an allowable threshold by accepting both of the first command and the third command, the second determination unit determines that the first command is not acceptable.

11. The vehicle control system according to claim 3, wherein,
when the vehicle is estimated to deviate from a traveling road by accepting both of the first command and the third command, the second determination unit determines that the first command is not acceptable.

12. The vehicle control system according to claim 1, wherein
the acceptance determination unit recognizes an operation result indicating whether the control target is operating normally, and determines whether the first command is acceptable based on the operation result.

13. A vehicle control method executed by a vehicle control system, the vehicle control system including at least one vehicle control device and an operation control device, which is disposed separate from the at least one vehicle control device and includes an operation control unit for controlling a control target,
the vehicle control method comprising:
receiving commands from multiple applications;
determining, in response to receiving a first command from one of the multiple applications, whether the first command related to the control target is acceptable;
transmitting a determination result to the one of the multiple applications; and
in response to determining that the first command is acceptable, outputting a second command based on the first command to the operation control unit.

14. A vehicle control program product stored in a computer-readable non-transitory storage medium, the vehicle control program product being executed by at least one vehicle control device to control a control target, the vehicle control program product comprising instructions that control the at least one vehicle control device to function as:
an output unit outputting, to an operation control program that controls the control target, a second command that is based on a first command, in response to input of the first command from an application;
an acceptance determination unit determining whether the first command related to the control target is acceptable; and
a determination transmission unit transmitting a determination result by the acceptance determination unit to the application,
wherein the acceptance determination unit includes a function of a first determination unit that determines whether the first command is acceptable based on at least one of a vehicle equipment, a vehicle state, or a command syntax included in the first command.

15. A vehicle control method executed by at least one vehicle control device to control a control target, the vehicle control method comprising:
outputting, to an operation control program that controls the control target, a second command that is based on a first command, in response to input of the first command from an application;
determining whether the first command related to the control target is acceptable;
transmitting a determination result to the application; and
determining whether the first command is acceptable based on at least one of a vehicle equipment, a vehicle state, or a command syntax included in the first command.

16. A vehicle control system comprising:
at least one vehicle control device;
an input unit to which commands from multiple applications are input;
an acceptance determination unit determining, in response to a first command being input from one of the multiple applications, whether the first command related to a control target is acceptable;
a determination transmission unit transmitting a determination result determined by the acceptance determination unit to the one of the multiple applications; and
an output unit outputting a second command based on the first command to an operation control unit that controls the control target when the acceptance determination unit determines that the first command is acceptable,
wherein the acceptance determination unit includes a first determination unit that determines whether the first command is acceptable based on at least one of a vehicle equipment, a vehicle state, or a command syntax included in the first command.

17. A vehicle control method implemented by at least one vehicle control device, the vehicle control method comprising:
receiving commands from multiple applications;
determining, in response to receiving a first command from one of the multiple applications, whether the first command related to a control target is acceptable;
transmitting a determination result to the one of the multiple applications;
in response to determining that the first command is acceptable, outputting a second command based on the first command to an operation control unit that controls the control target; and
determining whether the first command is acceptable based on at least one of a vehicle equipment, a vehicle state, or a command syntax included in the first command.

18. A vehicle control program product stored in a computer-readable non-transitory storage medium, the vehicle control program product being executed by at least one vehicle control device and comprising instructions that control the at least one vehicle control device to function as:
an input unit to which commands from multiple applications are input;
an acceptance determination unit determining, in response to a first command being input from one of the multiple applications, whether the first command related to a control target is acceptable;
a determination transmission unit transmitting a determination result determined by the acceptance determination unit to the one of the multiple applications; and
an output unit outputting a second command based on the first command to an operation control unit that controls the control target when the acceptance determination unit determines that the first command is acceptable,
wherein the acceptance determination unit includes a function of a first determination unit that determines whether the first command is acceptable based on at least one of a vehicle equipment, a vehicle state, or a command syntax included in the first command.

19. A vehicle control system comprising:
at least one vehicle control device;
an operation control device controlling a control target and disposed separate from the at least one vehicle control device;
a first management unit receiving a first command transmitted from an application and transmitting a management command, which is determined based on the first command;
a second management unit receiving the management command transmitted from the first management unit and transmitting a second command, which is determined based on the management command; and
a third management unit receiving the second command transmitted from the second management unit and controlling the control target based on the second command,
wherein at least one of the first management unit, the second management unit, or the third management unit includes:
an acceptance determination unit determining whether the first command or the second command, which is related to the control target, is acceptable;
a determination transmission unit transmitting a determination result determined by the acceptance determination unit to the application;
an output unit transmitting a command determined based on a command that is input; and
an operation execution unit controlling the control target based on the command that is input.

20. The vehicle control system according to claim 19, wherein
the at least one vehicle control device includes a first vehicle control device and a second vehicle control device,
the second vehicle control device is separate from the first vehicle control device,
the first vehicle control device includes the first management unit,
the second vehicle control device includes the second management unit, and
the operation control device includes the third management unit.

21. The vehicle control system according to claim 19, wherein
the first management unit includes:
a first acceptance determination unit determining whether the first command related to the control target is acceptable; and
a first determination transmission unit transmitting a determination result by the first acceptance determination unit to the application, and
the second management unit includes:
a second acceptance determination unit determining whether the second command related to the control target is acceptable; and
a second determination transmission unit transmitting a determination result by the second acceptance determination unit to the application via the first management unit.
